(19) United States
(12) Patent Application Publication
(10) Pub. No.: US 2008/0249803 A1
(43) Pub. Date: Oct. 9, 2008

(54) System and method for creating a marketing analysis model

(76) Inventors: Helene Monat, Holmdel, NJ (US); Steve Davis, Brookline, MA (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 12/099,103

(22) Filed: Apr. 7, 2008

Related U.S. Application Data
(60) Provisional application No. 60/910,542, filed on Apr. 6, 2007.

(51) Int. Cl. G06Q 10/00; G06Q 50/00

(52) U.S. Cl. 705/2

(57) ABSTRACT

A method of producing a marketing report, wherein the marketing report is based on at least one or more patient information data-sets and one or more purchasing information data-sets, can include the steps of receiving a first patient information data-set from a patient, transmitting a patient association request to a purchase tracking module, wherein the patient association request includes a portion of the first patient information data-set, and the purchase tracking module is configured to store purchasing information data-sets. The method can include receiving a patient association confirmation, wherein the patient association confirmation acknowledges the association of a portion of the first patient information data-set with a purchasing information data-set stored in the purchase tracking module, scheduling a time for transmission of a first educational information data-set to the patient and transmitting the first educational information data-set at the properly scheduled time to the patient.

### CROSS-REFERENCE TO RELATED APPLICATION

This application claims the benefit of U.S. Provisional Patent Application No. 60/910,542, filed Apr. 6, 2007, the contents of which are hereby incorporated by reference herein.

### BACKGROUND OF THE INVENTION

1. Field of the Invention

Embodiments of the invention relate to the utilization of purchasing data, within the field of therapeutic products, to provide marketing analysis information, and, more specifically, to systems and methods for linking direct marketing efforts with purchasing data to produce improved marketing models.

2. Description of the Prior Art

Successful marketing models often require numerous methods of interaction between customers and sellers. Theses methods may include customer surveys, direct advertising, and product educational programs. Through use of these methods, sellers are able to better understand the needs of a given target market as well as factors that effect purchasing patterns.

Given the importance of these customer interactions, sellers strive to optimize the effectiveness of each customer interaction. In order to better understand the effectiveness of a given customers interaction, many sellers track client purchasing habits in relation to a given customer interaction. For example, a company may mail direct marketing material to potential customers in a given geographic area. Subsequent to the mailing, the company may track product sales in the given geographic area to determine if the direct marketing material resulted in an increase in product sales.

Through use of modern communication networks, the ability for sellers to interact with customers, as well as track their purchasing habits, has greatly increased. Sellers can now more easily interact with individual customers. With this increased ability to interact with customers comes an increased risk of offending ones privacy. The risk of impinging on ones privacy is especially important when a seller is offering goods or services within the field of healthcare. Many customers are particularly weary of providing information to sellers when such information may touch on personal health related issues. In addition, governmental regulations, such as the Health Insurance Portability and Accountability Act (HIPAA), provide strict privacy standards that must be met when handling customer information relating to health care services.

Despite these limitations, sellers of health care related products and services, such as pharmaceutical companies, endeavor to pursue more effective methods of reaching potential customers and servicing existing customers.

In addition, consumers desire to have greater access to personalized information related to health care services, such as drugs that can help them overcome their ailments. Many consumers seek out information related to health case service and desired a method of receiving more personalized content in regards to these services.

Thus, a need exists for improved methods and systems for allowing sellers and customers, of health care related products and services, to effectively interact through use of modern communication networks.

### SUMMARY OF THE INVENTION

Embodiments of the invention are directed to systems and methods for creating a marketing report wherein the marketing report is based on patient information, educational information provided to patients, and product purchasing information. In addition, embodiments are directed to systems and methods for creating a monetization framework of allocating advertising funds, within the field of therapeutic products.

An embodiment of the invention may be deployed to create a marketing report that highlights successful elements of a given marketing campaign. A method according to this embodiment can include two parts: 1) interaction with a purchasing database; and 2) interaction with patients. The part that interacts with the purchasing database performs the steps of receiving patient information, associating patient information with data stored in a database configured to store information related the therapeutic product purchases, and receiving purchasing information from the database. The part that interacts with a patient performs the steps of determining the educational information to be transmitted to a patient, determining the schedule for the transmission of educational information, transmitting the educational information, and receiving of patient information in response to the educational information. Upon receipt of both purchasing information and patient information, the system performs analysis on this information. The result of this analysis can include an advertising monetization framework as well as a market campaign effectiveness report.

### BRIEF DESCRIPTION OF THE FIGURES

The above and other objects and advantages of the present invention will become apparent upon consideration of the following detailed description, taken in conjunction with the accompanying figures, in which like reference characters refer to like parts throughout and which:

FIG. 1 illustrates a block diagram of an exemplary system capable of creating the marketing analysis model described in accordance with embodiments of the present invention;

FIG. 2 is a process flowchart for illustrating steps employed in the creation of a marketing analysis model, in accordance with embodiments of the invention;

FIG. 3A is a screen shot that illustrates a survey question that could be presented to a patient, in accordance with embodiments of the invention; and

FIG. 3B is a screen shot that illustrates one possible use for the survey question presented in FIG. 3A, in accordance with embodiments of the invention.

### DETAILED DESCRIPTION

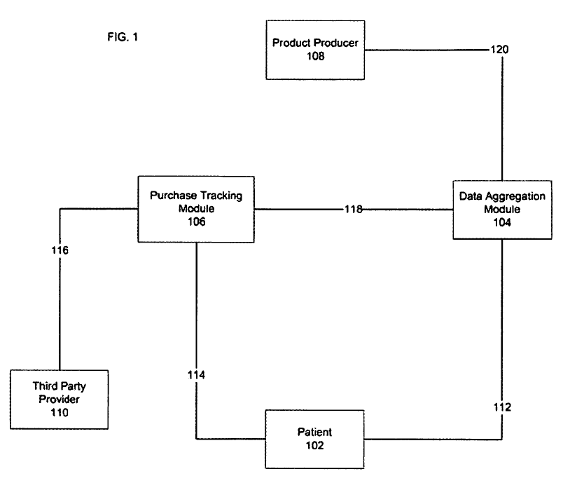

An exemplary embodiment of system 100 for creating a marketing analysis model is illustrated in FIG. 1. In the embodiment, system 100 can comprise patient module 102, Control Center Module (CCM) 104, Purchase Tracking Module 106 (PTM), Product Producer 108, and Third Party Provider module 110. Each of these modules may be communicably connected via wired or wireless communication channels.

In system 100, patient module 102 could include any user who interfaces with either CCM 104 and/or PTM 106. Patient 102 may interface with CCM 104 in response to an advertisement transmitted to patient 102 or in expectation of receiving educational information related to therapeutic remedies.

In system 100, CCM 104 acts as a point from which external elements primarily communicate. Patient 102, PTM 106, and Product Producer 108 are all communicably connected to CCM 104. In some embodiments, CCM 104 performs at least the function of process flow management, data aggregation, and statistical analysis.

In some embodiments, PTM 106 tracks the purchasing habits of patients in reference to a given set of products. In certain embodiments, PTM 106 may track therapeutic remedy purchases made by a given patient 102. The collected information may include information related to the name of a given therapeutic remedy purchased along with the number of refills available under a given therapeutic remedy prescription. The information stored within PTM 106 may be collected as a result of patient input. In such and embodiment, patient 102 would connected to PTM 106, via communication channel 120, following the purchase of a given therapeutic remedy or acquisition of a therapeutic remedy prescription. Once connection 114 has been established, patient 102 may provide information to PTM 106 regarding a recent therapeutic remedy purchase or acquisition of a therapeutic remedy prescription.

Alternatively, PTM 106 may acquire information regarding the purchase of a therapeutic remedy or acquisition of a therapeutic prescription via third party provider 110. The term “third party provider” is intended to include, but is not limited to, a retailer of therapeutic remedies, such as a pharmacy, or insurance company that is involved in handling claims related to the procurement of therapeutic remedies. In such embodiments where PTM 106 acquires information regarding the purchase of a therapeutic remedy or acquisition of a therapeutic prescription via a third party provider 110, the third party provider 110 and PTM 106 may be communicably connected via communications channel 116. Third party provider 110 may transmit to PTM 106 information related to recent sales of therapeutic remedies or receipt of prescriptions that may entitle a patient to a given therapeutic remedy. The information transmitted from third party provider 110 to PTM 106 may include the name of the therapeutic remedy and the name of patient purchasing the therapeutic remedy. This information may be transmitted from third party provider 110 to PMT 106 following each individual transaction, such as after the filling of a prescription, or third party provider 110 may aggregate the information and transmit such information in bulk to PTM 106.

Given that a majority of the information aggregated by PTM 106 is related to health care services, privacy is a primary concern. The system of PTM 106, provides that the identity of a given patient remains anonymous. Therefore, PTM 106 may aggregate data from a large number of users but, without additional functionality, it may not be possible for an outside party to associate a record to a given patient. Such data privacy is provided by associating a patient with an anonymous identifier, and then tracking patient purchases, survey results, and other data via the anonymous identifier.

To provide a greater level of service, to both patient 102 and product producer 108, Control Center 104 may allow patient 102 to create an association between the data stored by control center 104 and the data stored by PTM 106. By associating a given patient 102 to a portion of data stored by PTM 106, patient 102 has the opportunity to further augment the data stored by PTM 106 by providing additional information related to their health care experience. For example, patient 102 may visit a doctor in relation to a sleep disorder. The doctor may prescribe a sleep aid to combat this sleep disorder. When patient 102 fills the prescription for the sleep aid at his or her pharmacy, the pharmacy may share this information with PTM 106. Given the sensitive nature of this information, PTM 106 can store information related to the purchase of the sleep aid, or other therapeutic remedies, anonymously (via an anonymous patient identifier). Therefore, PTM 106 will keep track of the fact that patient 102 purchased the sleep aid but an outside party viewing the data stored by PTM 106 will be unable to link this purchase to the actual identify of patient 102.

However, there may be instances where patient 102 would like to provide additional information regarding their purchase of the prescribed sleep aid. In this situation, patient 102 may provide additional information to control center module 104, along with information that will allow control center module 104 to link such information with the quasi-anonymous information retained by PTM 106. As a result of linking the additional patient information with the information regarding the recent purchase of the sleep aid, control center module 104 can provide enhanced analysis regarding a doctor visit or marketing campaign.

Keeping with the example of an embodiment of the present invention where patient 102 purchases a prescription sleep aid to combat a sleep disorder, control center module 104 may collect a wide range of pertinent information from patient 102. Control center module 104 may collect information related to the interaction between doctor and patient 102 at the time when the prescription for the sleep aid was written. This additional information may include, but is not limited to, whether the doctor informed patient 102 as to the side effects of certain sleep aids, whether a free sample was provided, or whether the doctor suggested use of non-prescription remedies. Patient 102 would be free to provide control center module 104 with a varying amount of information. Control center module 104 would then be able to link such information with the purchasing information tracked by PTM 106.

In an alternative embodiment, patient 102 may connect to control center module 104 before a visit to a doctor in relation to a therapeutic issue. Given that patient 102 has yet to visit a doctor in relation to a therapeutic issue, patient 102 may be searching for educational information related to a certain therapeutic issue. Control center module 104 may prompt patient 102 as to information related to their therapeutic issue and upcoming doctor appointment. In response to such information, control center module 104 may provide patient 102 with educational information that may be beneficial to consult before, during, and after the doctor appointment. This educational information could include literature outlining possible therapeutic remedies in light of a given therapeutic issue.

Returning to the example where patient 102 suffers from a sleep disorder and has yet to visit a doctor in relation to this condition, patient 102 may connect to control center module 104 and provide information related to the patient's health issue. Such connections can be in the form of emails, pop-up advertisements, Web-based surveys, and/or other communications. This information may include severity of symptoms, date of future doctor appointments, and prior medical conditions. Having acquired this data set from patient 102, control center module 104 is now capable of cross-referencing this information with related information that may be stored, or later stored, in PTM 106. This may allows control center 104 to track the effectiveness of educational information provided to patient 102 before a given doctor appointment. For example, a patient 102 may provide information to control center module 104 regarding a case of hypertension. Patient 102 may also disclose to control center module 104 the fact that patient 102 will be visiting a doctor in regards to their hypertension within the coming weeks. Control center module 104 may provide patient 102 with educational information regarding a given therapeutic remedy that is effective at controlling hypertension, as well as a list of questions that patient 102 may want to ask their doctor during the up coming visit. Following the scheduled visit, control center module 104 may query PTM 106 to determine if patient 102 did in fact receive and/or fill a prescription for the therapeutic remedy that control center module 104 previously provided educational information about. This embodiment may enable control center module 104 to better track the effectiveness of educational information related to a given therapeutic remedy.

According to an embodiment of the invention, the output of the control center module 104 may be provided to a product producer 108. As used herein, the term “product producer” can include, but is not limited to, an entity that manufactures, distributes, or has an interest in a product (e.g., a pharmaceutical company), for which control center module 104 may have provided related educational information.

In embodiments of the invention, additional network components, modules, devices, and/or systems may be incorporated into system 100, as would be understood by one of skill in the art, as informed by the present disclosure.

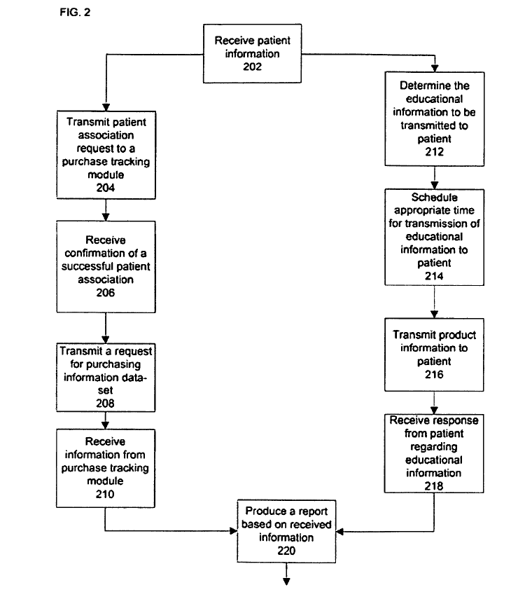

Embodiments of the invention can include a method 200 for providing a report to a product producer 108, as described in FIG. 2. The method 200 begins with the receipt of patient information 202. As described above, this information may include data regarding therapeutic needs, information relating to upcoming doctor appointments, and privacy waiver information. Returning to the example described above, patient 102 may be suffering from, for example, a sleep disorder. As a result, patient 102 may provide, in step 202, information related to this condition. This information may include current medical symptoms, therapeutic remedies currently consumed, name of treating doctor, and the date of any upcoming doctor visits in relation to the sleep disorder. This information may be received by control center module 104, or other like module.

Following the receipt of the patient information 202, a portion of the patient information is transmitted, at step 204, to PTM 106 in order to associate a portion of the patient information with a portion of the information managed by PTM 106. Fields that can be used to form the associations can include one or more of first name, last name, gender, date of birth, insurance ID number.

At step 206, control center module 104 receives notification that a portion of the patient information has been associated with a portion of the information managed by PTM 106. This association allows the control center module 104 to link the data within PTM 106 with a specific patient (e.g., by way of an anonymous identifier). Through this association, control center module 104 may track the relationship between educational information provided to patient 102 and purchases made by patient 102.

Having associated a portion of the patient information with a portion of the purchasing information, a request is transmitted to PTM 106 in order to retrieve purchasing information related to patient 102. In response to the transmission of a request for purchasing information, control center 104 may receive, at step 210, purchasing information from PTM 106. The purchase information received may be associated with a given patient. This information may include a list of therapeutic remedies purchased by the given patient and the number of available refills for a given therapeutic remedy. PTM 106 may manage additional data related to purchasing information, patient information, and combinations thereof.

In addition to communicating with PTM 106, in some embodiments, communications with patient 102 are also implemented. Steps 212-218 could occur concurrently, before, or after, the execution of steps 204-210.

In accordance with method 200, step 218 determines the educational or other information to be transmitted to patient 102. As used herein, the term “educational information” includes, but is not limited to, any information that may help a patient in better understanding a given therapeutic condition and possible therapeutic remedies. This could include pertinent questions to ask a doctor regarding a given therapeutic condition, benefits gained as a result of taking a given therapeutic remedy, comparisons between two or more therapeutic remedies, advertisements, or patient questionnaires. The educational information to be transmitted may be customized depending on the product or the intent of the communication. The determination as to the content of the educational information to be transmitted may be derived through an analysis of the patient information received in step 202. As described in the example above, a patient suffering from a sleep disorder may provide information, in step 202, including medical symptoms and the date of any future doctor appointment. Based on this information, step 212 may determine that patient 102 may benefit from educational information that describes the benefits achieved through use of a given sleep aid, information highlighting the advantages of such sleep aid over other leading brand or generics, or question that patient 102 should ask a doctor in relation to their sleep disorder.

In addition to using patient information to determine the content of the educational information, product producer 108 may also play a role in establishing this content. Given that some of the educational information content may be related to a product or service provided by product producer 108, product producer 108 may be given the ability to control the message provided to patient 102. This may allow product producer 108 to fine tune the educational information content provided to each user. For example, product producer 108 may produce a therapeutic remedy that reduces cholesterol. In such a case, product producer 108 may use an embodiment of the present invention to transmit education information regarding their therapeutic remedy which lowers cholesterol. However, it may be known that different segments of the target market for this therapeutic remedy respond to different marketing approaches. For example, men between the ages of 18-35 may be more likely to respond to education information that provides only positive features of the therapeutic remedy, while women 18-35 may response to education information that appears to be more balanced. Given this example, product producer 108 may have two (or more) sets of educational information that are tailored to different market segments. Through this ability to narrowly tailor the education information, product producer 108 may become involved, at step 212, in determining the content of educational information to be transmitted. In addition, as described below, a resultant output report from method 200 can be used to determine the effectiveness of certain educational information with respect to certain market segments as they relate to certain ailments and certain treatments.

Following the determination, at step 212, of the educational information to be transmitted, the method 200 continues at step 214 with the scheduling of the appropriate time for transmission of the educational information. Like the determination of the educational content to be transmitted, the scheduling the time for transmission may include analysis of patient information and product producer 108 information. Given an embodiment where patient 102 provides information regarding a therapeutic issue and patient 102 states that within the coming week he or she intends to visit a doctor in regards to the therapeutic issue, step 214 may determine that the appropriate time to transmit information to patient 102 may be two days before the given appointment. Input from product producer 108 may help determine the algorithm used in the process of determining the appropriate time for transmission of educational information. Step 214 may also determine that it is appropriate to schedule more than one transmission of educational information. In such an instance, either the same or different educational information may be transmitted at more than one time.

Having determined the content to be transmitted, at step 212, and the scheduling of the transmission or transmissions, at step 214, the selected educational information is transmitted as scheduled, at step 216. This transmission could be in the form of an email, short text service (SMS) message, Web page, Instant Message (IM), or other like transmission. Patient 102 may provide information in response to the transmitted educational information. According to method 200, in step 218 information is received in response to the educational information. The nature of such information will be dependent upon the educational information that was transmitted. The response could include a response to a questionnaire regarding the quality of the educational information or a rebate form in response to a coupon provided to patient 102. In some embodiments of the invention, this information may contribute to a greater understanding as to the effectiveness of the educational information on the purchasing habits of patient 102.

Having received, at step 210, information from PTM 106 related to product purchasing and, at step 218, information relating to educational information transmitted, step 220 of method 200 produces a report based in the product purchasing information and education information. As is described below, such a report is a useful, tangible and concrete output of the method 200. The substance of this report may vary depending upon the desired results.

In one embodiment, the report provides an analysis as to the effectiveness of certain education information provided to patient 102. In this embodiment, step 220 is primarily focused on the analyzing the effectiveness of different educational information on purchasing habits. For example, product producer 108 may be interested in determining what type of educational information provokes, or example, an arthritis patient to purchase a given therapeutic remedy. In order to accomplish this goal, step 216 may transmit a plurality of varying educational information packets regarding a given arthritis remedy. Once the educational information has been transmitted to a group of arthritis patients, step 220 will aggregate the data regarding education information transmitted, information received in response to the educational information, and information received from PTM 106 as to whether a given arthritis patient purchased the arthritis remedy. Based on the aggregated data, step 220 may link the specific educational information provided to a given arthritis patient with the facts regarding whether the arthritis patient purchased an arthritis remedy. As a result of linking educational information provided, with actual purchases made, a report can be generated that may highlights any correlation between the transmission of a given type of educational information with the purchase of a given type of therapeutic remedy. Therefore, the output of step 220 may be a series of correlations between education information, patient information, and purchasing information. This information may be used to design a new marketing campaign. In addition, this information may be used to optimize an existing marketing campaign.

In an alternative embodiment, step 220 may produce a report that may monetize advertising funds. In such an embodiment, a party may be interested in calculating the amount of sales generated as a result the distribution of a given piece of educational information. In an embodiment of the invention where the educational information is an advertisement for a given therapeutic product, product producer 108 may pay an advertiser a given amount of money in the even that patient 102 responses to a given advertisement by purchasing the advertised product. By linking the educational information with the purchasing information, as described above, step 220 may be capable of determining whether a given patient purchased a product after have been sent a specific piece of educational information. Through this process, step 220 may be capable of creating an advertising monetization framework.

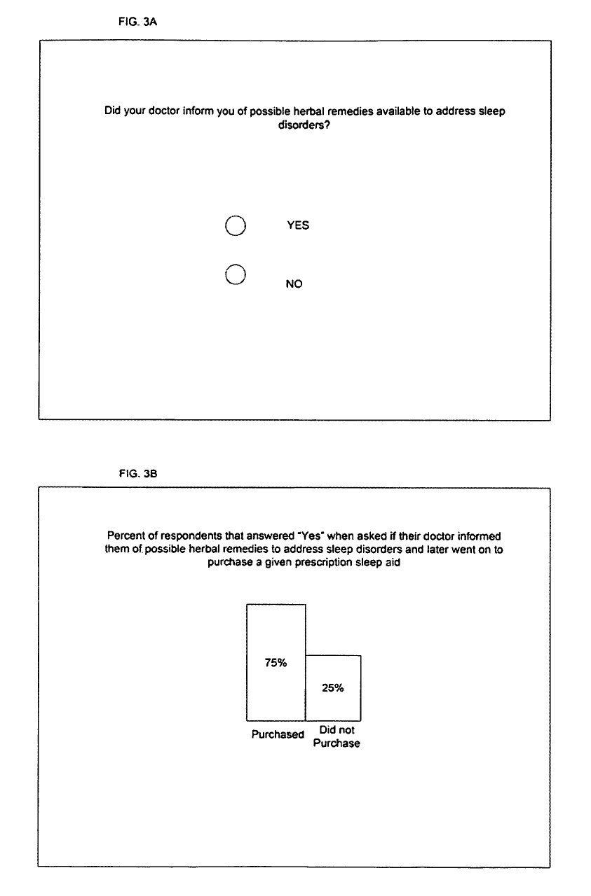

FIGS. 3A and 3B provide screen shots that illustrates an example of the type of information that may be disclosures by a patient, as well as, the use of such information. Keeping with the example of a patient that may be suffering from a sleep disorder, FIG. 3A may be one of many questions presented to a patient as part of an embodiment of the present invention. The question presented in FIG. 3A asks a patient whether their doctor informed them of possible herbal remedies that could be used to address a sleep disorder. Given the temporal nature of this question, a patient would be asked this question after having visited a doctor in regards to a sleep disorder. Assuming that patient 102 answered the question presented in FIG. 3A in the affirmative, their response would be included in the result illustrated in FIG. 3B.

FIG. 3B, illustrates a screen shot of a portion of a marketing report produced, according to an embodiment of the present invention. FIG. 3B illustrates one use for a portion of the information gathered as a result of the question presented in FIG. 3A. FIG. 3B illustrates that when a patient was informed, by his or her doctor, of possible herbal remedies to address sleep disorders, 75% of those surveyed went on to purchase the prescription sleep aid. In order to produce the results displayed in FIG. 3B, the answer to the question presented in FIG. 3A may be linked to product purchasing information. An embodiment of a linking method is described above with reference to method 200 and FIG. 2. The findings displayed in FIG. 3B could be used by a marketer of the given prescription sleep aid in order to better advise doctors as to information that may be discussed during a patient visit.

The foregoing description and corresponding figures are provided to illustrate an understanding of the principles of the present invention, and various modifications can be made by those skilled in the art without departing from the scope of the present invention described herein. Therefore, one skilled in the art will appreciate that the present invention can be practiced by other than the described embodiments, which are presented herein for purpose of illustration and not by way of limitation, and the present invention is limited only be the claims that follow.

1. A method of producing a marketing report, wherein the marketing report is based on at least one or more patient information data-sets and one or more purchasing information data-sets, comprising the steps of:
receiving a first patient information data-set from a patient;
transmitting a patient association request to a purchase tracking module, wherein the patient association request includes a portion of the first patient information data-set, and the purchase tracking module is configured to store purchasing information data-sets;
receiving a patient association confirmation, wherein the patient association confirmation acknowledges the association of a portion of the first patient information data-set with a purchasing information data-set stored in the purchase tracking module;
scheduling a time for transmission of a first educational information data-set to the patient;
transmitting the first educational information data-set at the properly scheduled time to the patient;
receiving a second patient information data-set in response to the transmitted first educational information;
transmitting a request for at least one purchasing information data-set associated the patient;
receiving, from the purchase tracking module, at least one purchasing information data-set associated with the patient; and
producing the marketing report based on at least a portion of the first patient information data-set, the second patient information data-set, or the purchasing information data-set.

2. The method of claim 1, wherein the first patient information data-set includes information associated with a therapeutic need of the patient.

3. The method of claim 2, wherein first educational information relates to a therapeutic remedy for the therapeutic need of the patient.

4. The method of claim 1, wherein the first patient information data-set includes information associated with the intent of the patient to visit a doctor in relation to a therapeutic need.

5. The method of claim 3, wherein scheduling a time for transmission of a first educational information set is related to the information associated with the intent of the patient to visit a doctor in the future.

6. The method of claim 1, further comprising;
utilizing the marketing report in order to produce an advertising monetization program.

7. A method for creating an advertising monetization program, based on one or more patient information data-sets received from a patient wherein the one or more patient information data-sets have been provided in response to one or more educational information data-sets, comprising the steps of:
receiving a first patient information data-set from the patient;
scheduling an appropriate time for transmission of one or more educational information data-sets to the patient;
transmitting the one of the one or more educational information data-sets to the patient;
receiving a second patient information data-set from the patient, in response to one of the one or more educational information data-sets; and
creating a monetization program based on at least a portion of the first data set or second patient information data-sets.

8. The method of claim 7, wherein the first patient information data-set comprises;
information related to a therapeutic issue affecting the patient, and information related to a date at which point the patient intends to visit a health care provider regarding the therapeutic issue.

9. The method of claim 8, wherein determining an appropriate time for transmission of one or more educational information data-sets comprises calculating a date prior to the date at which point the patient intends to visit a health care provider regarding the therapeutic issue.
